(19) United States
(12) Patent Application Publication
(10) Pub. No.: US 2021/0178983 A1
(43) Pub. Date: Jun. 17, 2021

(54) MODULAR RACK ASSEMBLY FOR AUTONOMOUS VEHICLES

(71) Applicant: PLUSAI CORP, Los Altos, CA (US)

(72) Inventors: Timothy Patrick Daly, JR., San Jose, CA (US); Hao Zheng, Saratoga, CA (US); David Wanqian Liu, Los Altos, CA (US); Jinpeng Li, San Jose, CA (US)

(21) Appl. No.: 16/723,763

(22) Filed: Dec. 20, 2019

Related U.S. Application Data
(60) Provisional application No. 62/948,787, filed on Dec. 16, 2019.

(51) Int. Cl. B60R 11/02; G05D 1/02

(52) U.S. Cl. CPC B60R 11/0264; B60R 2011/004; G05D 1/021

(57) ABSTRACT

A modular rack assembly for autonomous vehicles, and an autonomous vehicle having said modular rack assembly. The modular rack assembly includes a rail configured for placement onto a vehicle, e.g., a roof and/or near a front windshield. The rail has at least one sensor (radar, LiDAR, camera) mounted thereon. Connector(s) are provided on the rail to connect to one or more corresponding couplings on the vehicle. The connectors are communicatively tied to the sensor(s) for sending and receiving communication via the couplings when connected thereto. Also included is a controller that connects to a computer within the vehicle to communicate with the computer and the sensor(s). Connection of the rail to the couplings establishes communication between the controller and the computer, such that the controller is configured to send and receive signals to and from the computer and to and from the sensor(s) for controlling operation and driving of the autonomous vehicle.

### CROSS REFERENCE TO RELATED APPLICATION

This application claims priority to U.S. Provisional Patent Application No. 62/948,787, filed Dec. 16, 2019, which is hereby incorporated by reference herein in its entirety.

### BACKGROUND

### Field

The present disclosure is generally related to a modular rack assembly for autonomous vehicles. More specifically, the modular rack assembly that has one or more sensors thereon and is connectable to a vehicle to communicate with a computer of said vehicle and for controlling operation and driving of the autonomous vehicle.

### Description of Related Art

With the advancement of sensing technologies, automation in different industries relies on advanced sensing technologies to provide information about the surrounding of the automation site which forms the basis for various computerized decision makings. For example, different automated assembly lines in different manufacturing sites deploy various sensors to provide crucial information for the robots operating at such sites to operate properly. As another example, driverless vehicle is an emerging field where sensing technology is essential for facilitating the computer system in a moving vehicle to make correct vehicle control decisions in dynamic situations. In such applications, sensors in multiple modalities may be deployed on different parts of a vehicle in order to constantly provide observations of the surrounding of the moving vehicle. Such observations may include visual, acoustic, and 3D depth information. For instance, the moving vehicle needs to “see” clearly and accurately what obstacles are in the field of view and to determine various relevant parameters associated with each of the observed obstacles. For instance, an autonomous vehicle needs to determine what is the pose of each obstacle in the field of view, whether each such obstacle is in motion, what is the velocity of each such obstacle, and how far is each such obstacle from the moving vehicle at each moment. Such parameters need to be obtained based on continuous, clear, and accurate information from sensors in order for the computer system to successfully achieve obstacle avoidance in real time.

In particular, each of the sensors, devices, and components typically use mounts and cables that are different from the other devices and components. For example, such devices and components would typically be installed separately on the vehicle and calibrated by expert factory personnel or specifically trained technicians.

Other vehicle systems, such as Mobileye or Nauto, which can provide limited driver assistance such as navigation, recording, or accident warnings, typically have devices in a small, singular package.

### SUMMARY

It is an aspect of this disclosure to provide a modular rack assembly for a selected range of autonomous vehicles. The modular rack assembly includes a rail configured for placement onto a selected autonomous vehicle selected from the range of autonomous vehicles, the rail having at least one sensor mounted thereon; and one or more connectors provided on the rail configured to connect to one or more corresponding couplings on the autonomous vehicle. The one or more connectors are communicatively tied to the at least one sensor for sending and receiving communication via the one or more corresponding couplings when connected thereto. Also included is a controller configured to connect to a computer within the autonomous vehicle. The controller is configured to communicate with the computer and the at least one sensor. Connection of the one or more connectors provided on the rail to the one or more corresponding couplings establishes communication between the controller and the computer, such that the controller is configured to send and receive signals to and from the computer and to and from the at least one sensor for controlling operation and driving of the autonomous vehicle.

Another aspect provides an autonomous vehicle that includes a computer; one or more couplings provided on the autonomous vehicle, the one or more couplings being connected to the computer; a modular rack assembly comprising a rail having at least one mounted thereon; and one or more connectors provided on the rail connected to the one or more couplings on the autonomous vehicle. The one or more connectors are communicatively tied to the at least one sensor for sending and receiving communication via the one or more corresponding couplings. The vehicle further includes a controller communicatively connected to the computer. The controller is configured to communicate with the computer and the at least one sensor. Connection of the one or more connectors provided on the rail to the corresponding couplings establishes communication between the controller and the computer, such that the controller is configured to send and receive signals to and from the computer and to and from the at least one sensor.

Other aspects, features, and advantages of the present disclosure will become apparent from the following detailed description, the accompanying drawings, and the appended claims.

### BRIEF DESCRIPTION OF THE DRAWINGS

The systems, methods, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A is a schematic view of a modular rack assembly connected to an autonomous vehicle in accordance with an embodiment of this disclosure.

FIG. 1B shows a fleet of autonomous vehicles, each having sensors mounted thereon via the modular rack assembly as disclosed herein to facilitate autonomous driving, in accordance with an embodiment.

FIG. 1C shows an example of placement of the herein disclosed modular rack assembly on an autonomous vehicle to facilitate autonomous driving, in accordance with an embodiment.

FIG. 2 shows exemplary types of sensors that may be deployed on an autonomous vehicle, in accordance with an embodiment.

FIG. 3 is a schematic, detailed view of features of part of a rail of the modular rack assembly, in accordance with an embodiment.

FIGS. 4A and 4B show a front view and a right side view of an exemplary modular rack assembly with different types of sensors mounted thereon, in accordance with an embodiment.

FIGS. 5A and 5B show a front view and a right side view of an exemplary modular rack assembly with different types of sensors mounted thereon, in accordance with another embodiment.

FIG. 6 is an illustrative diagram of an exemplary computing device and architecture that may be used to implement features of the disclosure in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

An autonomous vehicle requires several kinds of sensors, antennas, and computers in order to function. The exact configuration of these hardware components will affect the capabilities and price of the autonomous vehicle. It is therefore important to be able to flexibly combine different components in a modular way to achieve different price targets and performance targets. Further, managing a fleet of autonomous vehicles containing such components—and replacement parts—may affect capabilities and flexibility. As such, this disclosure provides a system for autonomous vehicles that is simplified and provides a more uniform cabling and mounting system. Accordingly, mounts for sensors and cameras may be installed onto the system (e.g., rack), and electrical and data connections may be established, e.g., with a computer within the autonomous vehicle, for autonomous driving of the vehicle. Disclosed herein is a modular rack assembly that is a universal assembly for one or more different types of sensors used for autonomous driving of vehicles and that brings modular functionality to those sensor arrangements. As further described in detail below, the rack assembly may be interchangeable with a number of autonomous vehicles having couplings for connecting to connectors on said rack. Thus, different trucks and/or vehicles can be used with common internal and/or external parts (e.g., couplings) to make the overall rack assembly modular. By creating a uniform system for component mounting and interconnection as disclosed herein, the self-driving components may even be installed and reconfigured by non-expert users.

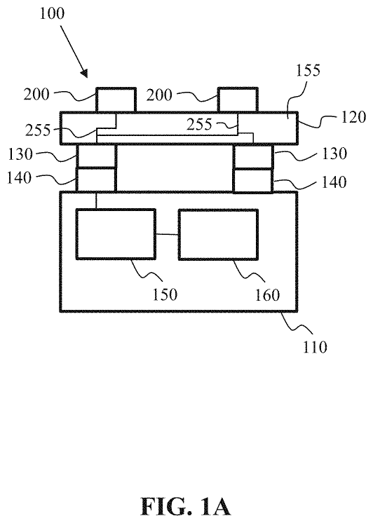

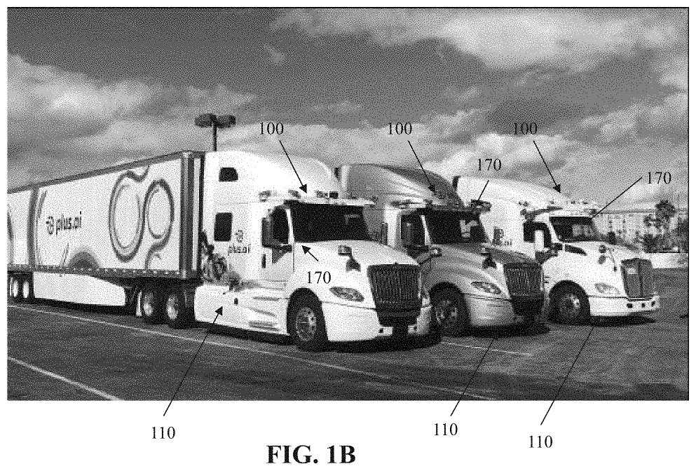

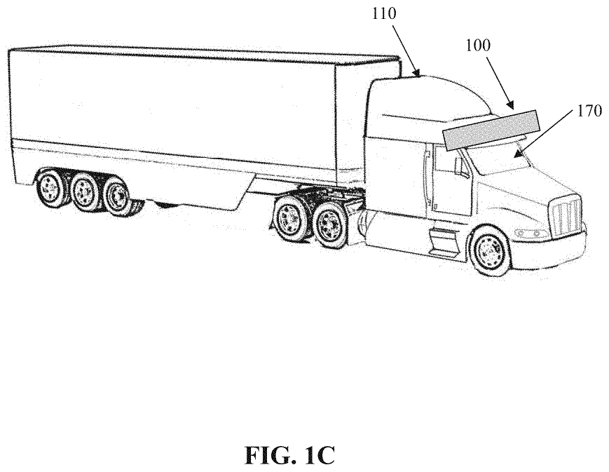

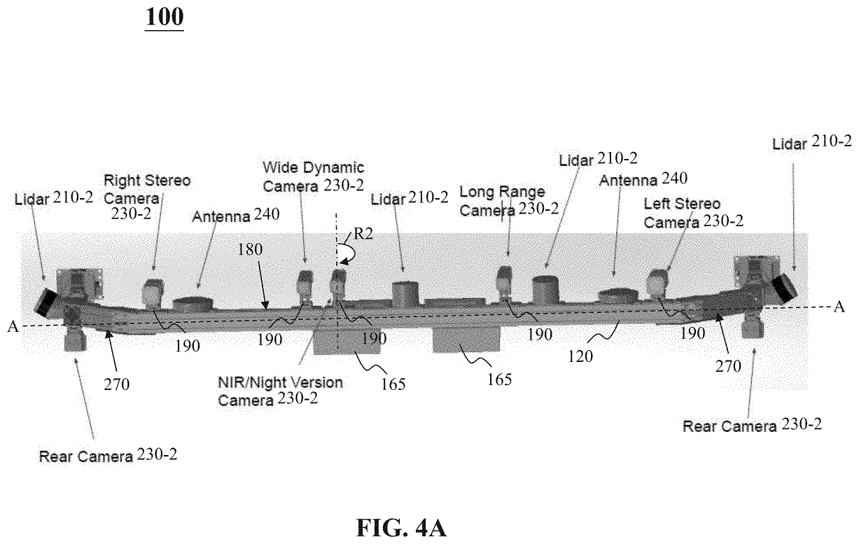

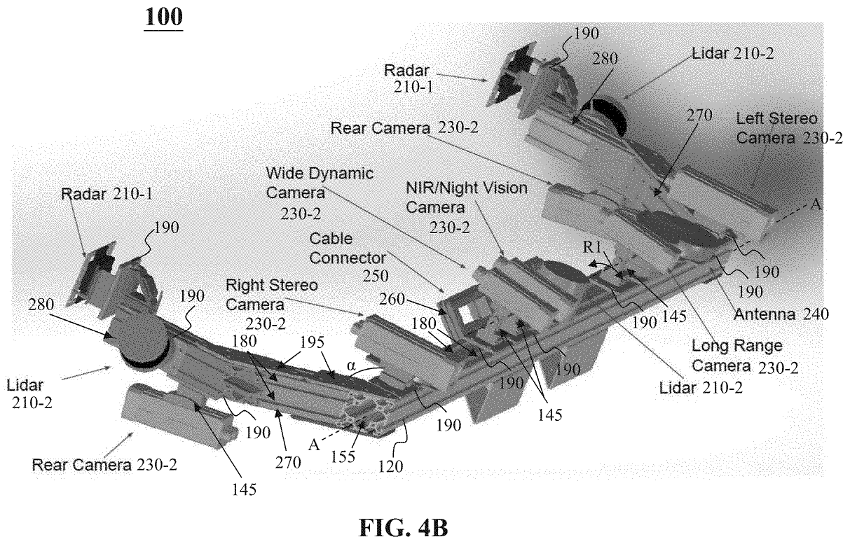

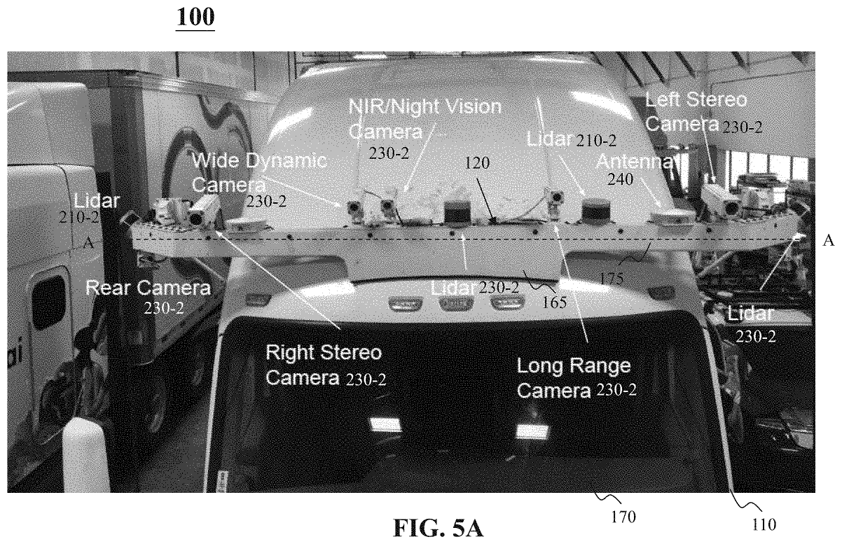

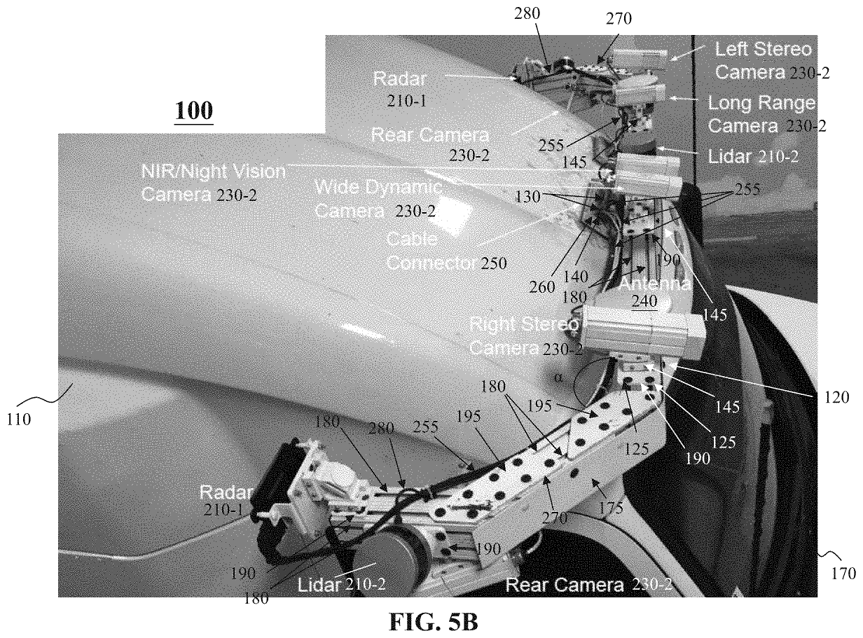

FIG. 1A schematically shows a modular rack assembly 100 which may be used for a selected range of autonomous vehicles 110, for example, vehicles pulling tractor trailers and/or trucks. The rack assembly 100 is removable and replaceable with respect to a vehicle 110. The rack assembly 100 may include one or more structures, including, but not limited to structures that are assembled to from a framework that is mountable and securable to a vehicle 110. The modular rack assembly 100 includes at least one rail 120, in accordance with an embodiment, configured for placement onto a selected autonomous vehicle 110 selected from the range of autonomous vehicles. The rail 120 in the exemplary illustrated embodiments includes at least a horizontal frame or piece; in some cases (such as shown in FIG. 5B), additional structures may be attached to the rail 120 to form the rack assembly 100. The rail 120 has at least one sensor 200 mounted thereon. In an embodiment, the one or more sensors 200 may be mounted to a top portion of the rail 120, such as shown and described in greater detail with reference to embodiments shown in FIGS. 4A-4B and 5A-5B. For example, in embodiments herein, multiple sensors 200 are provided on (and/or in) the rail 120 of the assembly 100, which may include one or more of: a radar sensor, a LiDAR sensor, a video camera, an antenna, and/or a night vision camera, for example.

One or more connectors 130 are provided on the rail 120 which are configured to connect to one or more corresponding couplings 140 on the autonomous vehicle 110, to effectively establish two-way communication between the sensor(s) 200 and a computer 160 associated with the vehicle 110. While the schematic in FIG. 1 shows two connectors 130 and two couplings 140, with the connector(s) 130 provided on a bottom of the rail 120, and the couplings 140 on a top of the vehicle 110, this depiction and number of devices is not intended to be limiting. Indeed, the number of connectors 130 and/or couplings 140 may vary in accordance with embodiments herein. Further, the placement of the connectors 130 and/or couplings 140 is not intended to be limited. In accordance with an embodiment, the connector(s) 130 of the rail 120 may be connected onto, within, or to the rail via cables and/or wiring 255 that are part of a wiring harness; that is, the connectors 130 do not need to be directly attached to the rail body itself.

The one or more connectors 130 are communicatively tied to the at least one sensor 200 for sending and receiving communication via the one or more corresponding couplings 140 when connected thereto. Each connector 130 may be a physical connector, designed to connect to or mate with a coupling 140, in accordance with an embodiment. For example, one of the connector and the coupling may include a male portion, whereas the other may include a female portion that may connect to the male portion. Also included is a controller 150 configured to communicate with the sensor(s) 200 and connect to a computer 160 within the autonomous vehicle 110. In an embodiment, the rack assembly 100 is configured to have at least one hard wired connection configured to mount to a computer or CPU provided in the vehicle 110. In some non-limiting embodiments, wireless connections may be used. The controller 150 may be configured to communicate with the computer 160 and the at least one sensor 200 via connecting the connector(s) 130 to the couplings 140. In accordance with embodiments, the connectors 130 may be quick connectors. In some embodiments, the connectors 130 may include pin-type connectors wherein pins are inserted into the couplings 140. In some embodiments, the connectors 130 may include plug-type connectors. Of course, a combination of different type of connectors 130 and couplings 140 may be implemented, in accordance with an embodiment. The connectors 130 and/or couplings 140 may be for power delivery and/or data transmission (or both). Connection of the one or more connectors 130 provided on the rail 120 to the one or more corresponding couplings 140 establishes two-way communication between the controller 150 and the computer 160, such that the controller 150 is configured to send and receive signals to and from the computer 160 and to and from the at least one sensor 200 for controlling operation and driving of the autonomous vehicle 110.

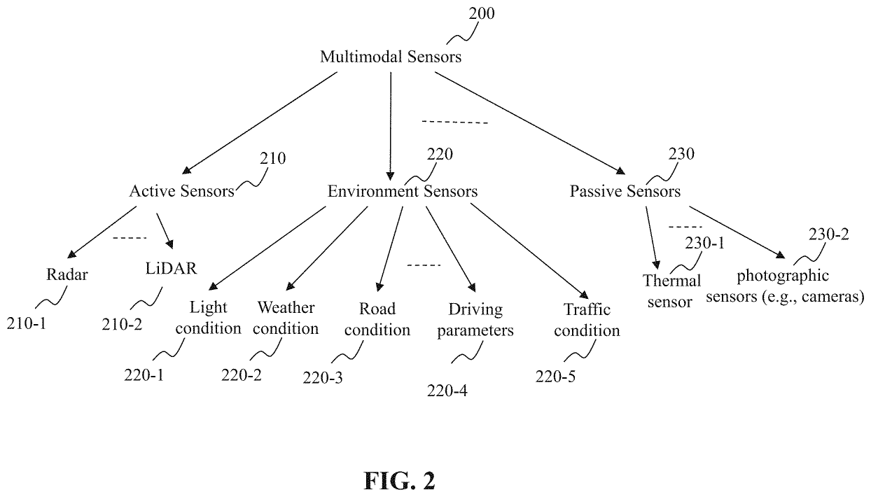

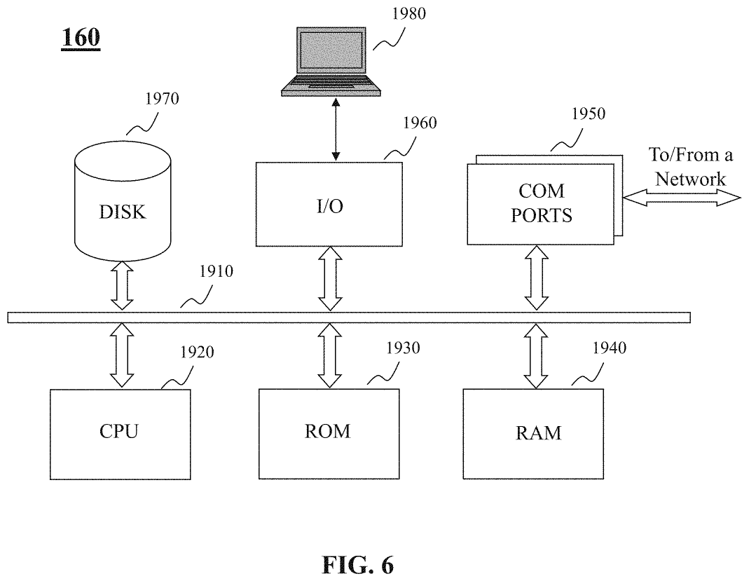

The computer 160 is configured to be part of a computer aided perception system supporting a fleet of autonomous driving vehicles, according to an embodiment. In one embodiment, the computer 160 may include features from U.S. Ser. No. 15/615228 (Published under U.S. Publication No. 20180348780), which is hereby incorporated by reference in its entirety. That is, the computer 160 may be an in situ perception system that utilizes certain models to perform computer aided perception and is capable of model self-adaption wherein each autonomous driving vehicle can locally adapt its models based on data acquired locally (i.e., via sensors 200). In an embodiment, each autonomous driving vehicle in operation has the ability to locally adapt its models using locally collected data to conform to the situation, while it may also benefit from events of interests collected by other vehicles via globally updated models from a global model update cloud. The computer 160 is configured to not only receive sensor data from sensor(s) 200, detect/track objects of interest from the sensor data, and perform local model adaptation based such data, and control the sensors 200 themselves (including, e.g., movement thereof) but also transmit such events of interest to the global model update cloud, and update object detection models when it received from the global model update cloud. Specifically, the computer 160 may include an object detection/tracking unit that receives video images from passive sensor(s) (e.g., video camera(s)) and performs object detection and tracking based on the video images), such as described later with reference to FIG. 2. Object detection includes not only identification of objects but also properties associated therewith such as depth, motion, etc. The computer 160 may be a general purpose computer or a special purpose computer. The computer 160 may be used to implement various functions associated with this disclosure via its hardware, software program, firmware, or a combination thereof. Although only one such computer is shown schematically, for convenience, the computer functions relating to the system as described herein may be implemented in a distributed fashion on a number of similar platforms, to distribute the processing load. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming and general operation of such computer equipment and as a result the drawings should be self-explanatory. Further details regarding computer 160 are generally described later with reference to FIG. 6.

The controller 150 is configured to send and receive signals to and from the computer 160 and to and from the sensor(s) 200. For example, readings from the sensor(s) 200 may received by controller 150 and processed via forwarding data and/or information to computer 160. The controller 150 may be configured to determine once a sensor 200 is added to the rack assembly 100 and establish communication with the computer 160 once the connector 130 is mated with the coupler 140. Thereafter, the controller 150 may receive readings from the sensor(s) 200 and communicate those readings and/or computations, determinations, etc. to the computer 160. In an embodiment, the controller 150 may be configured to send signals from the computer 160 to sensor(s) 200, e.g., to adjust said sensor(s) (e.g., to configure said sensors). Accordingly, the computer 160 and/or controller 150 may be used to monitor each of the sensor(s) 200 and send and receive instructions back and forth, as needed. The controller 150 may be provided in many forms, including, but not limited to, a circuit board with chips and/or processing components thereon.

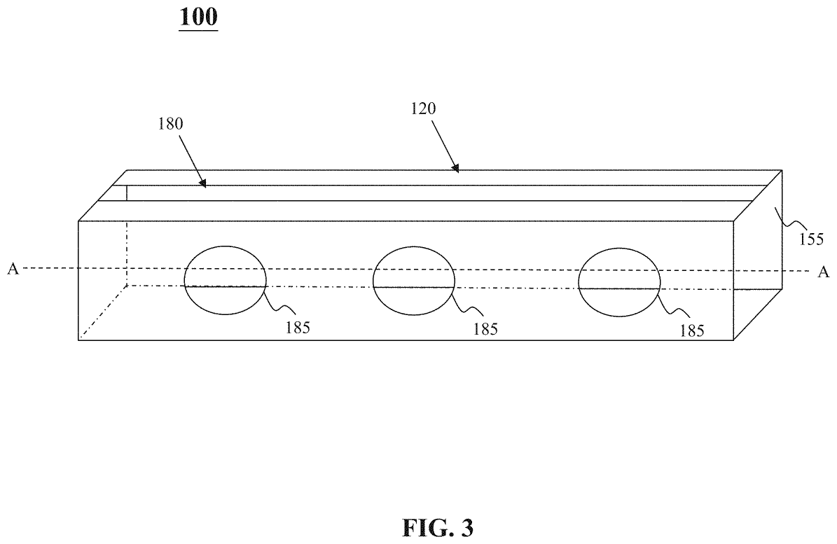

The modular rack assembly 100 is configured to be attached to a mounting surface of a vehicle 110. In accordance with an embodiment, the mounting surface may be a roof top (or simply “roof”) of a vehicle, for example. In an embodiment, the rack assembly 100 is configured to be placed laterally across a roof of the autonomous vehicle 110. In one embodiment, the mounting surface may be a portion of the vehicle 110 that is above and adjacent a windshield 170 of the vehicle 110, i.e., the roof portion near the windshield. FIG. 1B shows a fleet of autonomous vehicles, each having sensors mounted thereon via the modular rack assembly 100 as disclosed herein to facilitate autonomous driving. As shown, the modular rack assembly 100 may be positioned and attached above the windshield 170, in accordance with an embodiment. In an embodiment, the rail 102 is a longitudinal rail configured for attachment to a roof of the autonomous vehicle 110. As shown in FIG. 1C, for example, the longitudinal rail 102 may be positioned laterally across the roof of the autonomous vehicle such that a longitudinal axis A-A (see FIGS. 3, 4A, 5A) of the rail 102 is substantially parallel to a longitude of windshield 170 of the autonomous vehicle. The rack assembly 100 is configured, in accordance with an embodiment, to have at least one physical connector or structure 165 (see, e.g., FIGS. 4A and 5A) for mounting the assembly 100 to the vehicle 110.

FIGS. 1B and 1C and the illustrated embodiments are designed to shown one example of placement of the herein disclosed modular rack assembly 100 on an autonomous vehicle 110. However, it should be understood that the placement of modular rack assembly 100 may be altered and/or included with additional modular rack assemblies. For example, in an embodiment, different rack assemblies may be mounted at different parts of a vehicle to provide sensing information to facilitate autonomous driving, in accordance with an embodiment. Each rack assembly may have one or more sensors mounted thereon or therein. In an embodiment, rack assemblies may be installed on different locations of a vehicle or truck, such as on the top (e.g., roof of the passenger compartment), at a front (e.g., on a grille or bumper), and at sides of the vehicle, truck, or trailer. There may be parallel or counterpart of rack assemblies installed on the opposing sides of the vehicle (not shown). Each rack may also have different types of sensors mounted. A back of the vehicle, truck, or trailer may also have a rack assembly with sensors designated for observing features and/or objects behind a rear end of the vehicle. In this manner, the vehicle may be made aware of its surroundings so that any autonomous driving decision may be made according to the surrounding situation.

In another embodiment, such as described with reference to FIGS. 4A-4B and 5A-5B, the rail 120 may include side rails for attaching sensors that may be positioned to perform readings via the front, sides, and/or in back (behind) the vehicle.

Moreover, the fleet as shown in FIG. 1B is an example of the modularity of the herein disclosed rack assembly 100. Each vehicle 110 (i.e., truck) is configured to include couplings 140 for communicating with controller 150 and/or computer 160 once rack assembly 100 is mounted to the vehicle and the connectors 130 of the rack assembly 100 are connected to the couplings 140. Accordingly, rack assembly 100 may be interchangeable between each vehicle 110. Further, rack assembly 100 may be decoupled and disconnected from a vehicle 110 when service of the sensor(s) 200, rack assembly 100, and/or vehicle 110 is required. In some cases, a rack assembly 100 may be easily removed and mounted to another vehicle 110. Use of common internal parts (controller 150, computer 160) and/or external parts (like couplings 140) allows for removal and service of the rack assembly, and easier maneuvering of the sensors between vehicles. The rack assembly 100 further provides easier manipulation of the types of sensors used therewith by providing universal mounting structures for placement of different types of sensors thereon. Accordingly the assembly of sensors may be placed on (and/or removed from) the vehicle all together/at once via rack assembly 100.

FIGS. 4A-4B depicts an exemplary modular rack assembly 100 with different types of sensors 200 mounted thereon, in accordance with an embodiment herein. FIGS. 5A-5B depicts another exemplary modular rack assembly 100 with different types of sensors 200 mounted thereon, in accordance with another embodiment herein. As shown, the rack assembly 100 may have different types of sensors mounted thereon, including, but not limited to: stereo pair cameras (left and right stereo cameras), LiDAR sensors, at least one wide dynamic camera, at least one long range camera, at least one NIR/night vision camera, a pair of antennas, and a pair of rear cameras. As seen in FIG. 4B, for example, rear cameras may be positioned along side rail portions of the rail 120 such that they are positioned to obtain data and information towards and/or from a rear position relative to the passenger cab of the vehicle, for example. When the rack assembly 100 of FIGS. 4A-4B and/or FIGS. 5A-5B is installed on a vehicle, each of the sensors 200 installed therein may be deployed to play their respective sensing roles.

As previously noted, different types of sensors 200 may be deployed on an autonomous vehicle. FIG. 2 illustrates exemplary types of sensors that may be deployed on an autonomous vehicle 110 via attaching rack assembly 100, in accordance with an embodiment of this disclosure. While at least one sensor 200 is provided on and/or provided in the rack assembly 100, in an embodiment, multiple sensors 200 are included. The sensors may be multiple modality sensors 200. As shown in the Figures, each vehicle 110 may be equipped with a rack assembly 100 including different types of sensors, e.g., including active sensors 210, environment sensors 220, and/or passive sensors 230. Examples of active sensors 210 may include, but are not limited to, radar sensors 210-1 and LiDAR sensor 210-2, that act (emit and measure) actively to collect information needed. Examples of passive sensors 230 include, but are not limited to, photographic sensors such as (video) cameras 230-2 and/or thermal sensors 230-1 that collect data (video data) on whatever imprinted on them. Environment sensors 220 may include a diversified range of sensors, including sensors installed on the vehicle and ones that may be installed elsewhere but the vehicle may obtain the sensed information via network connections. Environmental sensor data that play a role in autonomous driving may be acquired. Examples include sensors data that indicate a light condition 220-1, a weather condition 220-2 such as whether it is snowing or raining, a road condition 220-3 such as whether the road may be wet, driving parameters 220-4 such as speed, . . . , and traffic condition 220-5 such as light, medium, or heavy traffic, etc. Environmental data from sensors 220 may also include (not shown in FIG. 2) time of the day, season, locale, etc.

Cameras 230-2 may include stereo cameras that are positioned on (and/or in) rack assembly 100 for observing obstacles located in front of the vehicle. For example, a stereo camera pair may be designated to not only see the scenes (objects such as trees, road signs, buildings, other obstacle vehicles, and lane marks, etc.) but also estimate the depth of the objects observed. LiDAR sensors 210-2 may be used for providing depth information of the front view and provide a depth map. Radar sensors 210-1 may be positioned at a number of places on the vehicle to sense the obstacles at the low height to detect any obstacles on the road surface in front of the vehicle. Additional cameras 230-2 (e.g., wide dynamic camera, night vision camera, long range camera, short range cameras) may also be provided on the rack assembly 100 for observing the road conditions and/or to detect the obstacles close to the road surface such as lane marks immediately before the vehicle. These exemplary sensors are installed at their designated positions and each is responsible for certain roles to gather specific type of information useful for the vehicle to make autonomous driving related decisions.

In accordance with one embodiment, the rack assembly 100 includes at least two lidar sensors, at least two radar sensors, at least two cameras, and at least one cellular antenna 240.

In an embodiment, the rack assembly 100 may further include one or more of: a GPS system, a GPS antenna, and one or more IMUS (inertial measurement units).

The number and types of rails, structures, and sensors (e.g., cameras, radar, LiDAR) used on the rack assembly 100 are not intended to be limiting, limited by the Figures, and/or limited by way of the controller, connectors 130, and/or electronics associated with the rack assembly 100. Rather, as will be understood by this disclosure, the disclosed rack assembly 100 is formed such that a number of compatible mounting devices (190) may be used for mounting and installation of different types of sensors 200, including antennas, and compute units. Further, the connectors and couplings may be configured such that power and data for the installed sensors, etc. is transmitted between the sensors, the controller, the computer and/or vehicle.

In an embodiment, at least a portion of the rail 102 is configured to conform to a body and/or contour of the mounting surface of the vehicle 110. For example, as shown and described later with respect to the embodiment in FIGS. 5A and 5B, the rail 102 may include a structural portion 165 that is configured for placement against the vehicle to assist in stabilizing and securing one or portions of the rail 102 to the vehicle 110. At least a part of this structural portion 165 may include a face or mating surface that is configured to conform (e.g., mate) with a surface of the vehicle 110. In one embodiment, the structural portion(s) 165 may include one or more mounting holes therein that are designed to receive securement devices (e.g., bolts or fasteners) to secure the rack assembly 100 to the vehicle 110.

In accordance with an embodiment, such as shown in FIG. 3, at least part of the rack assembly 100 comprises at least one longitudinal track 180 (shown here in part and in a partial detail view). The longitudinal track 180 may be designed to include one or more channels on along a top portion thereof, e.g., to guide movement of the sensors 200 (i.e., via their mounting brackets 190, as discussed below) to their position. These one or more channels may include openings therein, in accordance with one embodiment, that are connected to an open cavity 155 extending through the rail 120. In one embodiment, the track 180 is a T-track. In accordance with an embodiment, the channel(s) of the track 180 are configured to allow horizontal or lateral adjustment along a top of the rail 120 or track. In the exemplary embodiment of FIG. 3, a detailed view of part of a single track 180 is shown extending along rail 120. In the exemplary embodiments of FIGS. 4A-4B and 5A-5B, two parallel tracks are shown that extend along a length of the rail 120.

In an embodiment, each of sensor(s) 200 are connected to the rail 120 or rails of the rack assembly 100 via a mounting bracket 190. The mounting bracket 190 may be a universal mounting bracket that is configured to hold any type of sensor 200 and mount onto the rack assembly 100. In an embodiment, the mounting bracket 190 is configured for longitudinal movement (along axis A-A) along the rail 120. In an embodiment, the mounting bracket 190 is configured for longitudinal movement (along axis A-A) along the longitudinal track 180 for placement on and along the rail 120. In one embodiment, the mounting brackets 190 are configured to move along channel(s) of the track 180 within the rail 120. That is, the channel(s) are configured to guide movement of a corresponding portion of the mounting brackets 190 of the sensor(s) 200 laterally across the rail 120 or vehicle 110. The mounting brackets 190 may include an insertion portion that extends into an opening or channel of the track 180 and is guided therealong, for example. In an embodiment, wherein the track is a T-track, the mounting brackets 190 may move along the T-track and be secured thereto.

In an embodiment, the open cavity 155 is a central opening along a length thereof, such as shown in FIGS. 3 and 4B. The open cavity 155 or central opening may be configured to receive cables and/or wiring from the at least one sensor 200 of the assembly 100 therethrough. In an embodiment, connectors 130 are provided on ends of the cables and/or wires of the sensor(s) 200. An opening may be provided in the rail 120 to allow connectors 130 and/or portions of the cables and/or wiring therethrough.

In accordance with an embodiment, the mounting bracket 190 for a sensor 200 includes a locking device 125 configured to secure the at least one sensor along the rail 120 and/or rail assembly 100. More than one locking device 125 may be used to secure the mounting bracket 190. In an embodiment, locking devices 125 may include bolts, clamps, or clips, for example. As shown in FIG. 5B, the mounting brackets 190 may include a lip with holes therein configured to receive bolts or fasteners that extend through each hole in the lip of the mounting bracket 190 and into the rail 120 to secure a sensor 200 in place. In an embodiment, the fasteners may be inserted into a track 180 of the rail 120 (and/or rails 270, 280 (described below)) and/or rack assembly 100 and secured once placement of the mounting bracket 190 and thus sensor 200 is determined.

In an embodiment, one or more of the mounting brackets 190 for the sensors 200 may include a pivot joint 145. The pivot joint 145 may allow for tilting or pivoting of a respective sensor attached to the rail 120. In an embodiment, the pivot joint 145 enables pivotal or rotational movement about an axis that is generally parallel to longitudinal axis A-A, e.g., such that the sensor 200 mounted to the bracket 190 may be pivoted back and forth with respect to a back and a front of the vehicle 110 and the rail 120 (and/or rail 270, 280) of the rack assembly 100, such as shown by the example indicated by arrow R1 in FIG. 4B. In another embodiment, the pivot joint 145 may enable pivotal or rotational movement about an axis that is generally perpendicular to axis A-A, e.g., such that the sensor 200 mounted to the bracket 190 may be rotated in either direction (left or right) about a 360 degree axis relative to the rail 120 (and/or rail 270, 280) of the rack assembly 100, such as shown by the example indicated by arrow R2 in FIG. 4A. Accordingly, each of the sensors 200 may be adjusted such that they are configured to accurately obtain information (e.g., from the road, environment, surroundings, computer 160, GPS, etc.) while the vehicle 110 is in motion. For example, in an embodiment, by moving the pivot joint, a mounting angle of lens of a camera 230-2 may be adjusted and set to a desired position, either to move the camera lens up and/or down, or move the lens left and/or right, or both. A lock (not shown) may be used to secure each pivot joint 145 in position.

In some cases, the sensors 200 may be manually adjusted along the rails and/or to adjust their angles with respect to the vehicle 110. In some cases, the sensors 200 may be electronically adjusted. Adjustment of the sensors 200 may be performed before and/or after mounting of the rack assembly 100 to the vehicle 110. In some cases, adjustment of the sensors 200 may be performed during autonomous driving.

The rail 120 itself may have one or more holes 185 or openings therein, in accordance with an embodiment, shown in an exaggerated and partial form in FIG. 3 for clarification purposes only. In an embodiment, the holes 185 or openings may be provided on a back side surface, a bottom side surface, a top side surface, and/or a front side surface of the rail 120 or rack assembly 100. In an embodiment, one or more of the holes 185 may be the aforementioned openings that allow connectors 130 and/or cables and/or wiring to extend from inside the open cavity 155 of the rail 120 to an outside thereof. In an embodiment, one or more of the holes 185 may be mounting holes configured for receipt of a securement device for securement of the rack assembly to the autonomous vehicle.

In addition to the longitudinal rail (or track) 120, in accordance with embodiments, the rack assembly 100 may include one or more angled rail members 270 and/or one or more side rail members 280 (also referred to herein as rails 270 and rails 280, respectively). One or more brackets 195 and/or joints (e.g., elbow joints) may be used to connect the rail members 120, 270, and/or 280 to form the modular rack assembly 100. Fasteners may be inserted through the brackets 195 and connected to the rails (or tracks therein) for securement. Brackets 195 may also provide additional support to increase the stability of the assembly rack assembly 100. Accordingly, in addition to having a rail 120 generally being positioned across a roof and above windshield 170 on a front a vehicle 110, in accordance with embodiments herein, the rack assembly 100 may further include rails that extend around sides of the vehicle 110. These angled rail members 270 and/or side rail members 280 may, in accordance with embodiments, include one or more longitudinal tracks like the previously described track (180) to allow movement or adjustment of the sensor(s) 200, via mounting brackets 190) along a top of the rail 120 or track. In the exemplary embodiments of FIGS. 4A-4B and 5A-5B, two parallel tracks are shown that extend a length of each of the rails 270 and 280. Also like rail 120, in embodiments, rail members 270 and/or 280 may include an open cavity and/or central opening along a length thereof. This cavity or opening may be configured to receive cables and/or wiring from the at least one sensor 200 (e.g., radar 210-1, lidar 210-2, rear camera 230-2) therethrough. An opening may be provided in a side surface (e.g., back side surface) of the rail 120 to allow connectors 130 and/or portions of the cables and/or wiring therethrough.

In embodiments, one or more tracks (and channels) may be provided on any number of surfaces of the rail assembly 100. For example, one or more track(s) (and channels) may be provided on at least a top surface of the rails 120, 270, and 280. In an embodiment, one or more track(s) and channels may be provided on at least two surfaces of the rack assembly. In another embodiment, one or more track(s) and channels may be provided on at least three surfaces of the rack assembly. In one embodiment, such as illustrated in FIGS. 4B and 5B, the rails 120, 270, 280 of the rack assembly 100 may include one or more tracks on a top surface, an outward-facing (or front-facing) surface, and/or bottom surface thereof. Accordingly, the placement and mounting of sensors 200 need not be limited to a top surface of the rails of the rack assembly 100. As an example, the Figures show tracks on four surfaces thereof (the rails 120, 270, and 280 being of generally square configuration with four sides). As such, sensors (such as LiDAR 210-2) may be placed on an outer side of rail 280 to assist in sensing and obtaining information for autonomous driving of the vehicle. As another example, sensors (such as rear facing cameras 230-2) may be placed on either side (i.e., either rail 280) of the rail assembly 100 to sense and obtain information from objects (vehicles, environment) behind the vehicle 110, with respect to both left and right sides, during autonomous driving of the vehicle.

In the exemplary illustrated embodiment of FIGS. 4A-4B and 5A-5B, angled rail members 270 are provided at either end of the longitudinal rail 120 at an angle relative thereto. The angled rail members 270 may be positioned at an angle a (see, e.g., FIG. 5B) relative to the longitudinal axis A-A extending through the longitudinal rail 120. This may be an obtuse angle, as shown, i.e., greater than 90 degrees and/or equal to approximately 90 degrees. The angled rails 270 may assist in placement of sensor(s) 200 around a front and/or on sides of the vehicle 110, for example. In accordance with an embodiment, side rail members 280 may be connected to either angled rail member 270 such that they extend substantially parallel to, or an angle to, sides of the vehicle 110 (e.g., sides of the passenger compartment). That is, the rack assembly 100 may include a pair of side rail members 280 that extend generally in line with and along the sides of the vehicle 110. As mentioned above, side rails 280 may be positioned to receive sensors 200 that may be used to sense information relative to sides and/or a back (rear, behind) of the vehicle for use by the controller 150 and computer 160 during autonomous driving. In accordance with an embodiment, the side rail members 280 may be connected to the ends of the longitudinal rail 120 (instead of angled rail members 270). In accordance with an embodiment, side rail members 280 may be configured to extend beyond a plane along a side of the vehicle 110.

As previously mentioned, the one or more corresponding couplings 140 on the autonomous vehicle 110 may be placed in numerous locations. In accordance with one embodiment, at least one coupling 140 may be provided on the roof of a vehicle, such as illustrated in the exemplary embodiment of FIG. 5B. Specifically, in the example embodiment of FIG. 5B, the one or more corresponding couplings 140 are part of a cable connector assembly 250. This cable connector assembly 250 may include, for example, an interface 260 that is secured to the vehicle 110. The interface 260 may be configured to receive connectors 130 from one or more cables and/or wiring 255 from the sensor(s) 200 on the rail 120 of the assembly 100. As shown in the Figures, the cables and/or wiring may be part of a wiring harness that is positioned in and/or on and/or along the rail 120, in accordance with embodiments herein. The cable connector assembly 250 may include a frame that is mounted into the roof of the vehicle 110 to secure the interface 260 thereto. The interface 260 may be connected to the computer 160 for communication with the sensors 200 of the rack assembly 100.

In an embodiment, the cables and/or wiring 255 may be routed through the cavity 155 of the rail 120 (and/or rails 270, 280) and/or secured along portions of the rail 120 (e.g., via ties) and routed towards the couplings 140 and/or connector assembly 250.

In an embodiment, the controller 150 may be connected to the cable connector assembly 250. In one embodiment, the controller 150 may be provided as part of the interface 260.

As previously mentioned, the rack assembly 100 may be configured, in accordance with an embodiment, to have at least one physical connector or structure 165 (see, e.g., FIGS. 4A and 5A) for mounting the assembly 100 to the vehicle 110. Such structure(s) 165 may be attached to the rack assembly 100, e.g., to the rail 102. In an embodiment, the structure(s) 165 include a mating surface that is configured for placement against the mounting surface (e.g., roof and/or portion above the windshield) of the vehicle 110. The number of structures or portions 165 are not limiting. In the exemplary embodiment shown in FIG. 4A, for example, two structures 165 are provided that include angled surfaces for placement against the vehicle. In the embodiment shown in FIG. 5A, for example, a single structure that extends from the rail 120 may be utilized. The structures 165 may be used to secure the rail assembly 100 to the vehicle by placing fasteners therethrough and into a surface of the vehicle. In some cases, additional mounting devices, including magnets, may be used with rail assembly 100 to secure it to the surface of the vehicle 110. In some cases, a corresponding frame may be provided on a vehicle that receives and secures rack assembly 100. In addition, while not explicitly shown, it should be understood that any number of additional structures, frames, bars, fasteners, etc. may be used to secure the rack assembly 100 to the vehicle 110. For example, additional structures and/or fasteners may be provided to secure rails 270 and/or 280 to a side surface and/or roof of the vehicle 110 (e.g., sides or roof of the passenger compartment of a truck).

To enhance aesthetics, one or more fascia members 175 may be attached to the rails 120, 270, 280 and/or rack assembly 100. For example, fascia member(s) 175 maybe attached to at least front of the rail 120 to make the rack assembly 100 more streamlined with a fascia or surface of the vehicle. In one embodiment, the fascia members may be formed to assist in improving aerodynamics when the autonomous vehicle is in use.

Referring back to FIG. 6, shown is an example of a computer 160 and parts that may be provided as part of the computer 160 in vehicle 110. Computer 160, for example, includes COM ports 1950 connected to and from a network connected thereto to facilitate data communications. Computer 160 also includes a central processing unit (CPU) 1920, in the form of one or more processors, for executing program instructions. The exemplary computer platform includes an internal communication bus 1910, program storage and data storage of different forms (e.g., disk 1970, read only memory (ROM) 1930, or random access memory (RAM) 1940), for various data files to be processed and/or communicated by computer 1900, as well as possibly program instructions to be executed by CPU 1920. Computer 160 also includes an I/O component 1960, supporting input/output flows between the computer and other components therein such as user interface elements 1980. Computer 1900 may also receive programming and data via network communications. Hence, aspects of the methods of dialogue management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming. All or portions of the software may at times be communicated through a network such as the Internet or various other telecommunication networks. Such communications, for example, may enable loading of the software from one computer or processor into another, for example, in connection with conversation management. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution. Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Reference throughout the specification to “one embodiment” or “an embodiment” or the like means that a particular feature, structure, or characteristic described in connection with an embodiment is included in at least one embodiment of the subject matter disclosed. Thus, the appearance of the phrases “in one embodiment” or “in an embodiment” or the like in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

While the principles of the disclosure have been made clear in the illustrative embodiments set forth above, it will be apparent to those skilled in the art that various modifications may be made to the structure, arrangement, proportion, elements, materials, and components used in the practice of the disclosure. For example, while polygonal or square rails 120, 270, 280 are generally shown in the Figures, it should be understood that in some embodiments, the rails 120, 270, 280 may be tubular structures.

Further, features described with respect to rail 120 may also apply to the rails 270, 280, though they may not explicitly be described with respect to rails 270 and/or 280. Furthermore, any reference to movement of parts with respect to rail 120 may further apply to rails 270 and/or 280 as well as the rack assembly 100 as a whole. In accordance with embodiments, the rails 270 and/or 280 may be formed of similar structure and include features that have been described with reference to rail 120.

Additionally, as previously noted with respect to FIGS. 1B and 1C, it should be understood that the placement of modular rack assembly 100 may be altered and/or included with additional modular rack assemblies. While the rack assembly 100 is shown as being mounted laterally across a roof of the autonomous vehicle 110 and/or above a windshield 170 thereof, the placement of the rack assembly 100 should not be limited to what is shown in the Figures. Rather, as noted, the modular rack assembly 100 is configured to be attached to any number of mounting surfaces of a vehicle 110. Accordingly, it should be understood that, in some embodiments, mounting the rack assembly 100 to a roof may include mounting the rack assembly with respect to a back of the vehicle, which may or may not include a back window of the vehicle. Also, in some embodiments, the rack assembly 100 may be configured for attachment to a trailer of a truck. Placement on the trailer may include, for example, a front portion of the trailer (i.e., the portion of the trailer that connects to the passenger compartment) and/or a back portion of the trailer (i.e., the portion that may include one or more doors for access to inside the trailer, or at a rear of the trailer). In some cases, the rack assembly 100 may be mounted to sides of the vehicle or trailer. Attaching the modular rack assembly 100 to a rear and/or sides of a vehicle and/or trailer may further facilitate autonomous driving by providing additional views around and/or behind the vehicle while driving/in motion.

It will thus be seen that the features of this disclosure have been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A modular rack assembly for a selected range of autonomous vehicles, the modular rack assembly comprising:
a rail configured for placement onto a selected autonomous vehicle selected from the range of autonomous vehicles, the rail having at least one sensor mounted thereon;
one or more connectors provided on the rail configured to connect to one or more corresponding couplings on the autonomous vehicle, the one or more connectors being communicatively tied to the at least one sensor for sending and receiving communication via the one or more corresponding couplings when connected thereto; and
a controller configured to connect to a computer within the autonomous vehicle, the controller being configured to communicate with the computer and the at least one sensor;
wherein the connection of the one or more connectors provided on the rail to the one or more corresponding couplings establishes communication between the controller and the computer, such that the controller is configured to send and receive signals to and from the computer and to and from the at least one sensor for controlling operation and driving of the autonomous vehicle.

2. The modular rack assembly according to claim 1, wherein the rack comprises a longitudinal track, and wherein the at least one sensor is connected to the rack via a mounting bracket, the mounting bracket configured for longitudinal movement along the longitudinal track for placement on the rail.

3. The modular rack assembly according to claim 2, wherein the mounting bracket comprises a locking device, and wherein the locking device is configured to secure the at least one sensor along the rail.

4. The modular rack assembly according to claim 1, wherein the rack comprises one or more mounting holes therein, wherein the one or more mounting holes are configured for receipt of a securement device for securement of the rack assembly to the autonomous vehicle

5. The modular rack assembly according to claim 1, wherein the rail comprises a central opening along a length thereof, the central opening configured to receive cables and/or wiring from the at least one sensor therein.

6. The modular rack assembly according to claim 1, wherein the at least one sensor comprises a plurality of sensors selected from the group consisting of: a radar sensor, a LiDAR sensor, a video camera, and a night vision camera.

7. The modular rack assembly according to claim 1, wherein the rack is configured to be placed laterally across a roof of the autonomous vehicle.

8. An autonomous vehicle comprising:
a computer;
one or more couplings provided on the autonomous vehicle, the one or more couplings being connected to the computer;
a modular rack assembly comprising a rail having at least one mounted thereon;
one or more connectors provided on the rail connected to the one or more couplings on the autonomous vehicle, the one or more connectors being communicatively tied to the at least one sensor for sending and receiving communication via the one or more corresponding couplings; and
a controller communicatively connected to the computer, the controller being configured to communicate with the computer and the at least one sensor;
wherein the connection of the one or more connectors provided on the rail to the corresponding couplings establishes communication between the controller and the computer, such that the controller is configured to send and receive signals to and from the computer and to and from the at least one sensor.

9. The vehicle according to claim 8, wherein the rail is a longitudinal rail configured for attachment to a roof of the autonomous vehicle, wherein the longitudinal rail is positioned laterally across the roof of the autonomous vehicle such that a longitudinal axis of the longitudinal rail is substantially parallel to a longitude of a windshield of the autonomous vehicle.

10. The vehicle according to claim 9, wherein the rack comprises a longitudinal track, and wherein the at least one sensor is connected to the rack via a mounting bracket, the mounting bracket configured for longitudinal movement along the longitudinal track for placement on the rail.

11. The vehicle according to claim 10, wherein the mounting bracket comprises a locking device, and wherein the locking device is configured to secure the at least one sensor along the rail.

12. The vehicle according to claim 8, wherein the rack comprises one or more mounting holes therein, wherein the one or more mounting holes are configured for receipt of a securement device for securement of the rack assembly to the autonomous vehicle

13. The vehicle according to claim 8, wherein the rail comprises a central opening along a length thereof, the central opening configured to receive cables and/or wiring from the at least one sensor therein.

14. The vehicle according to claim 8, wherein the at least one sensor comprises a plurality of sensors selected from the group consisting of: a radar sensor, a LiDAR sensor, a video camera, and a night vision camera.

15. The vehicle according to claim 8, wherein the rack is configured to be placed laterally across a roof of the autonomous vehicle.

16. The vehicle according to claim 8, wherein the one or more corresponding couplings on the autonomous vehicle are provided on the roof.

17. The vehicle according to claim 16, wherein the one or more corresponding couplings are part of a cable connector assembly, the cable connector assembly being configured to receive one or more cables and/or wiring from the at least one sensor.
